(19) United States
(12) Patent Application Publication
(10) Pub. No.: US 2020/0330308 A1
(43) Pub. Date: Oct. 22, 2020

(54) OVERLAY FOR MASSAGE HEADREST

(71) Applicant: THE SPA CIRCLE LTD, Thame (GB)

(72) Inventor: Carmen Helen HOMSY, London (GB)

(21) Appl. No.: 16/387,785

(22) Filed: Apr. 18, 2019

(51) Int. Cl. A61G 13/00; B32B 7/12; B32B 5/26; B32B 7/022; B32B 1/08; B32B 5/02; A61G 13/12

(52) U.S. Cl. CPC A61G 13/009; B32B 2307/756; B32B 5/26; B32B 7/022; B32B 1/08; B32B 5/02; A61G 13/121; B32B 2250/20; B32B 2262/08; B32B 2307/538; B32B 2307/536; B32B 2601/00; B32B 2307/724; B32B 2307/732; B32B 7/12

(57) ABSTRACT

The present disclosure provides a fabric overlay for a massage table or headrest. The overlay includes: a first fabric portion having an aperture therethrough, the aperture defined by an inner edge of the first fabric portion, wherein the first portion is configured to extend in a first plane, and a second fabric portion formed into a tube and having first and second ends, wherein the first end of the second portion is joined to the first fabric portion so that the tube extends around the aperture and extends away from the first plane. The fabric of the overlay includes a first layer of fabric bonded to a second, different, layer of fabric, wherein the first layer is a fabric top layer and the second layer is a breathable polymer membrane. In use, the overlay provides a comfortable, washable barrier between the patient's skin and the surface of the massage headrest.

The present disclosure relates to an overlay for a massage headrest and a method of making an overlay for a massage headrest.

### BACKGROUND

A massage table is generally a padded table upon which a person lies face down to receive a massage. Sometimes the massage is for medical purposes, in which case the recipient may be considered a patient. Sometimes massage is for non-medical purposes; however, for consistency, the recipient will be referred to as a “patient” throughout the present disclosure, on the understanding that this disclosure applies to both medical and non-medical massage.

The massage table generally has a headrest, formed as part of the table or as an extension or attachment. Massage headrests can also be used for resting the head during a massage even when a patient is not lying on a table, e.g. for patients on chairs or massage stools. The headrest contains an aperture for the patient's face so they may lay comfortably, facing forwards, while lying on their front or, if not lying, positioned face down. Without the aperture, it is uncomfortable for a person to lie or sit with their face pressing into the headrest and so, in such situations, a person will usually turn their head to one side which will affect the positioning and tension in the neck, back, and shoulder muscles that may be the subject of the massage.

For hygiene purposes, some kind of replaceable barrier is placed between the patient (who may be naked or mostly unclothed) and the headrest so that the replaceable barrier may be removed after each patient's massage and replaced by a fresh one.

One commonly used barrier is a paper sheet laid over part of the massage table or the entire table. The masseuse or other person punches a hole in the paper sheet at the location of the aperture in the table where the patient's face goes, so that when the patient lies face down on the table, their forehead and cheeks rest on the headrest and their face, particularly the nose and mouth area, is left free and not abutting any material. This makes it easy to breathe while allowing the patient to relax into the headrest without putting uncomfortable pressure on their nose in particular. After the massage, the paper sheet is thrown away. Disposable paper sheet is less eco-friendly than other, washable, overlays.

Another commonly used solution is to place a folded towel around the aperture in the massage headrest, where the folded towel has been folded into a generally triangular shape leaving a central aperture free where the patient can rest their face. To do this, a typical towel may be folded a few times and bent into a generally triangular shape with the aperture in the center for the patients' nose and mouth area. Folded towels are generally resilient and pliable and this may improve the patient's comfort when resting their face on the towel. Such a towel overlay often leaves indentations (marks) on the user's face from the towel material. Further, a folded towel provides a very variable thickness of padding for the users face, which can lead to an imperfect patient-posture during use, by tilting the patient's head forward or backward creating tension in the neck, shoulder and back muscles. The creases formed by folding the towel over itself also can leave very visible furrows in the patient's skin lasting over minutes or hours. A folded towel will often be greater than 2 cm thick and this can tilt the patient's head backwards, obscuring the sub-occipital muscles at the base of the skull. Some headaches and radiating pain are related to these muscles and so a thick-overlay that leads to the patient's head tilting backwards inhibits treatment of these muscles. The rest of the table may be covered with another towel or with paper sheet. After the massage, the towel(s) may be washed and reused.

Another known solution is to use a cotton sheet or terrycloth sheet as an overlay. Cotton sheets as overlays are prone to crinkles and folds which leave marks of the patient's body or face. Similarly, terrycloth also leaves marks on the patient's body or face due to the loops of fabric in the terrycloth. Creases in such overlays may form during use from small movements of the patient, even if the overlay was initially laid flat.

Such conventional barriers for a massage table/headrest have generally been considered acceptable for their intended purpose. However, is it desirable to have a more reusable barrier not having the problems mentioned above.

### SUMMARY

According to a first aspect, the disclosure provides a fabric overlay for a massage headrest, the overlay comprising: a first fabric portion having an aperture therethrough, the aperture defined by an inner edge of the first fabric portion, wherein the first portion is configured to extend in a first plane; and a second fabric portion formed into a tube and having first and second ends, wherein the first end of the second portion is joined to the first fabric portion so that the tube extends around the aperture and extends away from the first plane; wherein the fabric comprises a first layer of fabric and a second, different, layer of fabric, wherein the first layer is a fabric top layer and the second layer is a breathable polymer membrane.

The first layer may be a very smooth natural or synthetic fabric, such as viscose, polyester, or bamboo. Although other smooth and soft fabrics may be used for the top layer.

The membrane layer provides structural rigidity to the fabric top layer and thereby ensures that the overlay is crease-free (or “wrinkle-free”). Such fabrics are also commonly called “non-iron”, which term expresses that the fabric will hold its shape after washing and will not need to be ironed to ensure the fabric remains crease/wrinkle free. That is, such crease-free/wrinkle-free/non-iron fabrics resist external stress and hold their shape after washing.

The fabric may further comprise a third layer, bonded to the adjacent second layer, wherein the third layer is a padded textile layer. The third layer is bonded to the second layer, i.e. so that the third layer is separated from the first layer by the membrane layer. Put another way, the layers may be ordered such that, in use, the first layer is in abutment with the patient's face, the second layer is adjacent the first layer, and the third layer is adjacent the second layer and in abutment with the massage apparatus.

The padded textile layer may be a natural or synthetic padded material. For example, a woollen layer or a microfleece layer or foam layer etc. Such fabrics provide padding and therefore extra comfort. Some massage tables and chairs do not contain padding and so having a third padded textile layer in the overlay can improve comfort on such massage apparatuses. Sometimes the padding of a massage apparatus may consist of leather or synthetic leather over wood. In such cases, the overlay 10 may protect a patient's face from being marked by seams in the leather.

The first end of the tube may be sewn to the first fabric portion at or near the inner edge, or the first end of the tube may be glued or heat sealed at or near the inner edge of the first fabric portion. Alternatively, the overlay may be formed as a single piece, e.g. by 3D weaving techniques.

The first fabric portion has an outer edge that may define one of a square shape, a round shape, or an oval shape. The desired shape will be partly determined by the size and shape of the massage headrest, as well as by aesthetic considerations.

The first fabric portion and second fabric portion may be made from a resilient fabric having a thickness greater than or equal to 2 mm and less than or equal to 5 mm. A resilient fabric provides some padding that can improve the comfort of a patient on a massage table, but keeping the fabric thickness low is useful to avoid propping up the patient's face which could introduce undesirable strain in the patient's neck, shoulders, and/or back muscles during the massage. Thus, an intermediate thickness is advantageous where the overlay provides some padding but is not so thick as to distort the patient's posture.

The first fabric portion and second fabric portion may be made from a machine washable fabric. This means that the overlay can be washed after each use and then reused for another patient in future. This can reduce waste compared to single-use paper towel overlays.

The fabric may be a multi-layer fabric. A multi-layer fabric comprises at least two layers that will usually be different materials. The first layer (that is adjacent a patient's skin, in use) may be selected for comfort, e.g. not a rough material, hypoallergenic, not textured in a manner that may leave marks on skin etc. The subsequent layers may provide different properties, such as improved strength for the overlay, or sweat-absorbancy etc. The sportswear industry has developed a large number of multi-layer fabrics for similar purposes of fabric strength, skin-feel, sweat absorbency, stain resistancy etc.

The first portion of the overlay may have a constant fabric thickness. This ensures that the overlay provides a flat surface that does not significantly distort the shape of the underlying massage table. By comparison, folded towels as described above, provide a very variable thickness that can tilt the patient's head in various ways, which can lead to undesirable tension in the neck, back, and/or shoulders during massage.

A strap may be connected to the second fabric portion. A strap may provide a convenient means for holding the overlay, e.g. when placing it on a massage table, as well as convenient means to ensure that the second portion extends properly through the aperture of the massage table. Preferably the strap is connected to the second fabric portion at or near the second end. Further preferably, the strap is connected to the second portion at two places, such that the strap extends from one portion of the tube to another. The strap may be in the patient's view during the massage but is not in contact with the patient's face. A company logo, inspirational message, or other advertising may be printed on the strap to sit in the patient's view during massage. The strap may also be impregnated with a scent. The strap is preferably a single-layer fabric strap, such as cotton. However, the strap may be a two-layer or a three-layer fabric. For example, the strap may be made of the same fabric as the first and second portions.

According to another aspect, the present disclosure provides a massage arrangement comprising: a massage headrest having a first surface containing a massage headrest aperture for receiving a person's face; and the overlay according to the first aspect, wherein the aperture of the overlay is substantially the same size and shape as the massage headrest aperture, such that, in use, the second fabric portion extends through the massage headrest aperture and the first fabric portion lays on the first surface of the massage headrest.

Preferably, the overlay is not folded over itself at any region. This ensures that the overlay provides a constant thickness so that a patient's head is not tilted in any undesired manner (e.g. as often happens with folded towels).

According to another aspect, there is provided a method of manufacturing an overlay for a massage headrest, the method comprising: forming a first fabric portion having an aperture therethrough, the aperture defined by an inner edge of the first fabric portion, wherein the first portion is configured to extend in a first plane; forming a second fabric portion by forming rectangular fabric portion into a tube by connecting two opposing sides of the rectangle together, such that the other two sides of the rectangular fabric portion provide first and second ends of the tube; connecting the first end of the tube to the first portion so that the second portion extends around the aperture and extends away from the first plane to form the overlay, wherein the fabric of the overlay comprises a first layer of fabric and a second, different, layer of fabric, wherein the first layer is a fabric top layer and the second layer is a breathable polymer membrane.

By this method, the first and second portions can both be cut from a flat sheet of fabric and then formed into the three-dimensional shape of the overlay by joining the two parts together.

The method may further comprise forming a strap having first and second opposed ends; and connecting the first end of the strap to a first point on the second end of the tube, and connecting the second end of the strap to a second point on the second end of the tube.

By this method, the strap can also be formed from the same flat sheet of fabric as the first and second portions.

On different overlays, the aperture may have different sizes. Different designs of massage tables and massage chairs have different shapes and sizes of apertures for the patient's face. The presently disclosed overlay may therefore be sized appropriately for a given massage apparatus.

The aperture may have any shape. Generally, oval, stadium-shaped, or circular apertures are preferred. These shapes are more suited to the shape of a human face and are simple to manufacture. A stadium-shape is a geometric shape having two parallel sides and, at each end a regular curve (such as a semi-circle or semi-oval) connects the two parallel sides.

Having the spa overlay made of washable fabric improves the re-usability of the overlay. Paper sheet is typically single-use in massage as paper is not washable.

### DESCRIPTION OF THE FIGURES

Certain embodiments of the present disclosure will now be described in greater detail by way of example only and with reference to the accompanying drawings in which:

FIG. 1 shows a schematic side view of a patient lying on a massage table with an overlay in accordance with the disclosure;

FIG. 2 shows a first perspective view of an overlay for a massage table according to the disclosure;

FIG. 3 shows a second perspective view of the overlay of FIG. 2;

FIG. 4 shows a plan view of the overlay of FIGS. 2 and 3;

FIG. 5 shows a cross-section of a two-layer fabric; and

FIG. 6 shows a cross-section of a three-layer fabric.

### DETAILED DESCRIPTION

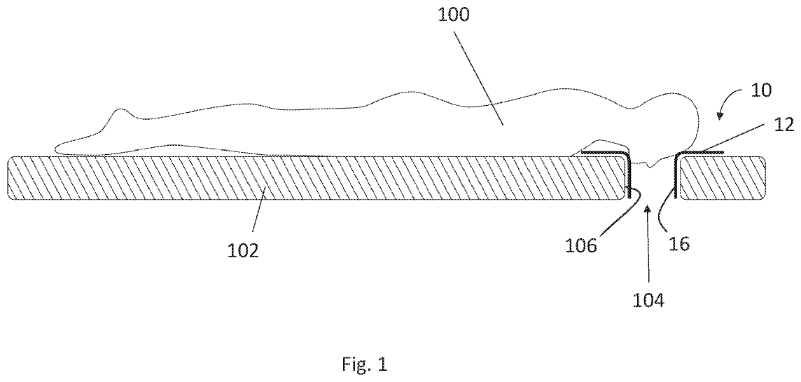

FIG. 1 shows an overlay 10 providing a barrier between a patient 100 lying face down on a massage table and the massage table 102. Massage tables are typically padded for the patient's comfort. The massage table 102 has a head part with an aperture 104 for receiving the patient's face comfortably. The aperture 104 of the massage table 102 has a sidewall 106. When the patient 100 is lying face down on the massage table, the patients face partially extends through the aperture. In this case, the sidewall 106 (if the overlay is not present) will directly abut the patient's forehead and cheeks. This design of massage table 102 allows the patient 100 to relax on the massage table 102 and lie comfortably face-forwards, i.e. without turning their head either left or right. The overlay 10 lies between the patient 100 and the surface of the massage table 102 and extends at least partially through the aperture 104 so that, when the patient 100 is on the massage table 102, the patient's forehead and cheeks are in contact with the overlay 10 and not in direct contact with the surface of the massage table 102. The overlay 10 is removable from the massage table 102 and may be replaced with a new overlay or washed between uses. Thus, the use of overlays, such as the present overlay 10, allows for multiple different patients to use the same massage table, one after the other, in a hygienic manner Some other form of overlay may be used between the user's body and the massage table 102, such as a towel or paper, if required for hygiene. Alternatively, the overlay 10 may be sufficiently large to cover enough of the massage table/chair such that a separate overlay (e.g. towel or paper) is not required.

In other massage apparatuses (not shown), there may be an adjustable extended headrest portion. For example, some massage tables have the headrest movable relative to the rest of the massage table, and in massage chairs the headrest is typically movable relative to the seat of the chair. While the following disclosure generally makes reference to a massage table 102, it is to be understood that the overlay 10 of the present disclosure is also applicable to other massage headrests, such as those just described.

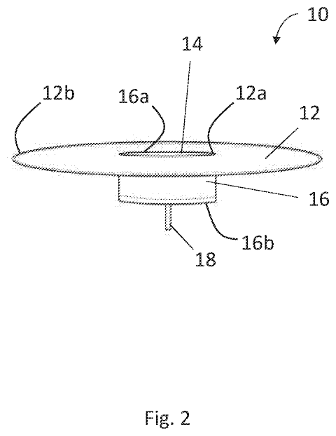

FIG. 2 shows a perspective view of the overlay 10 for a massage headrest. The overlay 10 comprises a first portion 12 that, in use, sits on the upper surface of the massage table 102. That is, the first portion extends generally in a first plane that is defined by the massage headrest. The first portion has an aperture 14 that is for receiving a patient's face. The aperture is defined by an inner edge 12a of the first portion 12. Thus, the aperture 14 is shaped and dimensioned to generally correspond to a normal human head. Thus, in various examples the aperture may be circular, oval, stadium-shaped or any other shape. The aperture will have characteristic length and width measurements in the region of 5 to 25 cm. This may provide a sufficiently large aperture that the patient's nose and mouth area is not covered. The first portion 12 also has an outer edge 12b that may define any suitable shape. In the example shown, the outer edge 12b defines a circular shape, however other shapes are envisaged. The first portion may have a characteristic length (e.g. diameter, for a circular first potion) of from 30 to 50 cm.

A second portion 16 is connected to the first portion 12. The second portion forms a tube that extends around the aperture and away from the plane of the first portion. Preferably, the second portion is connected to the first portion at or near the inner edge 12a. In use, the second portion 16 hangs down from the first portion 12 and extends at least partially through the aperture 104 of the massage table 102.

The second portion 16 is generally cylindrical having a first end 16a and an opposed second end 16b. The first end 16a is connected around the inner edge 12a of the first portion. Thus, in the disclosed embodiment, the shape of the second portion 16 matches the shape of the aperture 14 defined by the inner edge 12a. The second portion 16 may extend away from the plane of the first portion 12 by any length but preferably the generally cylindrical shape has a length of 5 to 15 cm.

A strap 18 may be provided attached to the second portion 16. In the embodiment shown, the strap 18 is connected at the second end 16b, however the strap 18 may connect to other areas of the second portion 16. The strap 18 may allow easy handling of the overlay 10. For example, the strap 18 may provide a convenient handhold by which to push/pull the second portion 16 through the aperture 104 in the massage table 102. The strap 18 may make it easier to place the overlay 10 in the correct position before use and make it easier to remove the overlay 10 after use. The strap 18 has been omitted from FIG. 1 for clarity. A first end of the strap 18 may be connected to the second portion 16 at a first location on the second end 16b, and a second end of the strap 18 may be connected to a second location on the second end 16b. Thus, the strap 18 may generally span across the aperture 14a between the first and second locations. In use, the strap 18 will be suspended beneath the patients' face and not touching the patient's face, for comfort.

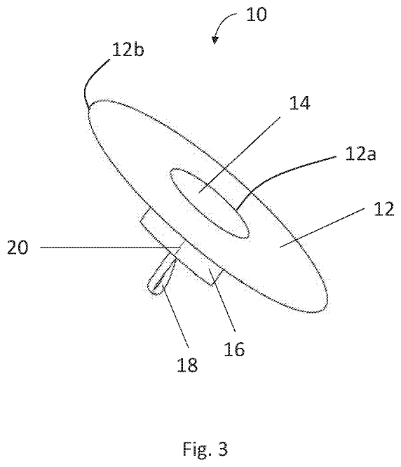

FIG. 3 shows a second perspective view of the overlay 10. With reference to this Figure, the second portion 16 may be formed from a generally rectangular section of fabric that is formed into a tube by sewing together two opposing ends of the rectangle. Line 20 in FIG. 3 denotes the line of sewing. Alternatively, adhesive or some other form of joining could be used. The second portion is thereby formed into a generally cylindrical piece, as discussed above, having the first 16a and second ends 16b. The first end 16a may then be sewn, e.g. around the inner edge 12a, of the first portion 12 so as to extend around the aperture 14. Other attachment methods, other than sewing, are also envisaged. For example, the second portion 16 may be glued or heat-sealed to the first portion 12. Alternatively, the second portion 16 may be formed integrally with the first portion 12, such as by 3D weaving techniques.

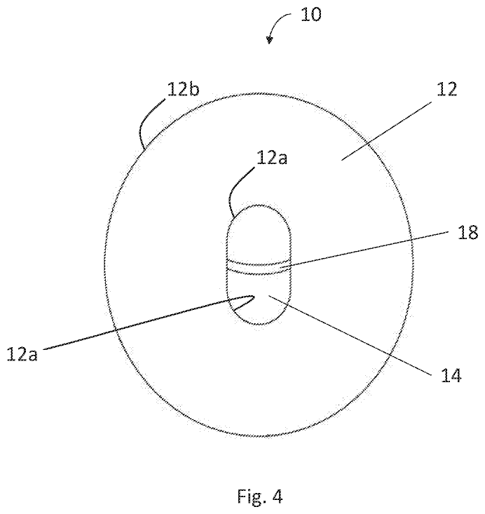

FIG. 4 shows a plan view of the overlay 10. This example has a stadium-shaped aperture 14. A stadium shape is a shape having two parallel sides, joined together at either end with a curved (e.g. hemispherical) portion—this is similar to the shape commonly used for sports stadia.

The first 12 and second 16 portions are made of fabric. The strap 18, if present, may also be made of fabric—the strap 18 may be made from the same or different fabric as the fabric for the first and second portions, e.g. yarn, fibres, woven material, ribbon etc. A fabric is any cloth made from yarn or fibres by weaving, knitting, felting or the like. Many fabrics and garments are sufficiently robust to withstand repeated washing in a washing machine and such fabrics/garments are commonly called “machine washable” and will often be identified as such on a care label on the garment. By contrast, paper is generally not machine washable as, in a washing machine cycle, the cellulose structure will lose all structural integrity and fall apart and/or dissolve in the washing machine. Thus, paper is not considered “washable” or “machine washable” for this reason.

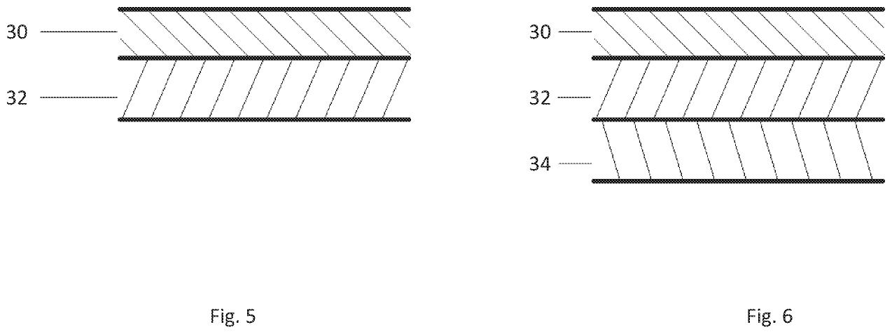

FIGS. 5 and 6 schematically show cross-sections of two-layer and three-layer fabrics, respectively. The fabric for the first 12 and second 16 portions is a two-layer fabric (see FIG. 5) or, optionally, a three-layer fabric (see FIG. 6). The top layer 30 is a fabric top layer. This layer is adjacent the patient's skin, in use. Therefore, the top layer 30 preferably has one or more of the following features: soft, hypoallergenic, stain-resistant, and smooth (i.e. untextured). The second layer 32 is to ensure the overlay 10 remains crease-free. Creases in known overlays (e.g. towels, terrycloth etc.) readily mark a patient's face during a massage and are therefore undesirable. The second layer 32 provides structural rigidity to the overlay 10 such that it holds its smooth, uncreased, shape during placement on the massage apparatus and during use. The second layer 32 is a breathable polymer membrane. In one example, the membrane is polyester. However other polymer membranes that maintain the overlay crease-free in this manner may also be suitable.

The fabric for the first and second portions may further comprise a third layer 34, as shown in FIG. 6. That is, the fabric may be a three-layer fabric. This three-layer fabric has the same layers 30,32 as the two-layer fabric, with the addition of a padded textile layer 34. For example, the padded textile layer 34 may be a microfleece or woolen layer. Preferably, the three layers 30,32,34 are bonded together, in order (i.e. first layer 30, second layer 32, then third layer 34), such that the membrane layer 32 is sandwiched between the first 30 and third 34 layers. The third layer 34 provides some padding to the overlay 10.

I claim:

1. A fabric overlay for a massage headrest, the overlay comprising:
a first fabric portion having an aperture therethrough, the aperture defined by an inner edge of the first fabric portion, wherein first portion is configured to extend in a first plane; and
a second fabric portion formed into a tube and having first and second ends, wherein the first end of the second portion is joined to the first fabric portion so that the tube extends around the aperture and extends away from the first plane;
wherein the fabric of the overlay comprises a first layer of fabric bonded to a second, different, layer of fabric, wherein the first layer is a fabric top layer and the second layer is a breathable polymer membrane.

2. The overlay according to claim 1, wherein the first end of the tube is sewn to the first fabric portion at or near the inner edge, or wherein the first end of the tube is glued or heat sealed to the first fabric portion at or near to the inner edge of the first fabric portion.

3. The overlay of claim 1, wherein the first fabric portion has an outer edge, the outer edge defining one of a square shape, a round shape, or an oval shape.

4. The overlay of claim 1, wherein the first fabric portion and second fabric portion are made from a resilient fabric having a thickness greater than or equal to 2 mm and less than or equal to 5 mm.

5. The overlay of claim 1, wherein fabric further comprises a third layer, bonded to the adjacent second layer, wherein the third layer is a padded textile layer.

6. The overlay of claim 5, wherein the padded textile layer is a woollen layer or a microfleece layer.

7. The overlay of claim 1, wherein the first portion of the overlay has a constant fabric thickness.

8. The overlay of claim 1, wherein a strap is connected to the second portion, preferably wherein the strap is connected at or near the second end of the second portion.

9. The overlay of claim 8 wherein the strap is connected to the second portion at two places, such that the strap extends across the tube.

10. A massage arrangement comprising:
a massage headrest having a first surface containing a massage headrest aperture for receiving a person's face; and
the overlay according to claim 1, wherein the aperture of the overlay is substantially the same size and shape as the massage headrest aperture, such that, in use, the second fabric portion extends through the massage headrest aperture and the first fabric portion lays on the first surface of the massage headrest.

11. The massage arrangement according to claim 10 wherein the overlay is not folded over itself at any region.

12. A method of manufacturing an overlay for a massage headrest, the method comprising:
forming a first fabric portion having an aperture therethrough, the aperture defined by an inner edge of the first fabric portion wherein first portion is configured to extend in a first plane;
forming a second fabric portion by forming rectangular fabric portion into a tube by connecting two opposing sides of the rectangle together;
forming a second fabric portion by forming rectangular fabric portion into a tube by connecting two opposing sides of the rectangle together, such that the other two sides of the rectangular fabric portion provide first and second ends of the tube;
connecting the first end of the tube to the inner edge of the first portion so that the second portion extends around the aperture and extends away from the first plane to form the overlay, wherein the fabric of the overlay comprises a first layer of fabric and a second, different, layer of fabric, wherein the first layer is a fabric top layer and the second layer is a breathable polymer membrane.

13. The method according to claim 12, further comprising forming a strap having first and second opposed ends; and
connecting the first end of the strap to a first point on the second portion.

14. The method according to claim 13, further comprising
connecting the second end of the strap to a second point on the second portion such that the strap extends across the tube.

15. The method according to claim 12, wherein the fabric is a machine washable fabric.

16. The method according to claim 12, wherein the fabric of the overlay further comprises a third layer, bonded to the adjacent second layer, wherein the third layer is a padded textile layer.
